(19) United States
(12) Patent Application Publication
(10) Pub. No.: US 2008/0062052 A1
(43) Pub. Date: Mar. 13, 2008

(54) Wireless communication terminal

(75) Inventors: Hiromichi Suzuki, Tokyo (JP); Akihiro Tsujimura, Tokyo (JP); Takashi Amano, Soka-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/899,591

(22) Filed: Sep. 6, 2007

(30) Foreign Application Priority Data
Sep. 7, 2006 (JP) P2006-243357

(51) Int. Cl. H01Q 1/50; H01Q 1/22

(52) U.S. Cl. 343/702; 343/860

(57) ABSTRACT

According to an embodiment of the invention, there is provided a wireless communication terminal including; a deformable body made of a flexible material; an antenna; a radio frequency part of which a position relative to the antenna is valiable according to a deformation of the deformable body; a strain sensor detecting the deformation of the deformable body; a matching circuit acquiring an impedance matching with respect to the antenna; and a matching control unit configured to make matching control of the matching circuit according to a result of the detection of the strain sensor.

### CROSS-REFERENCE TO RELATED APPLICATIONS

This application is based on and claims the benefit of priority from the prior Japanese Patent Application No. 2006-243357, filed on Sep. 7, 2007; the entire contents of which are incorporated herein by reference.

### TECHNICAL FIELD

The present invention relates to a wireless communication terminal such as a cellular phone.

### BACKGROUND

### Description of Related Art

Recently, a cellular phone has been equipped with various functions and has become a high-performance device; and, from the viewpoint of design, the cellular phone has been reduced in the weight, thickness and size thereof, leading to the development of a cellular phone which uses a flexible circuit board as its main circuit board. In this case, the problem is the impedance matching with respect to an antenna. JP-A-2004-15307 discloses a cellular phone which checks whether its body is held in a folded state or is held open for a call or the like to thereby control a capacity to be connected to the antenna.

It is expected not only that the cellular phone can be further diversified in design, but also that there can be developed a cellular phone having a built-in radio function which can be mounted into part of clothes or accessories which a user wears. To cope with such expected future trend, it can also be supposed that the cellular phone itself is made of a material which has no rigidity but can be prevented against damage even when it is dropped or trod; and, specifically, the body of the cellular phone may be made of resin such as rubber or may be made of a resin member which can fulfill its expected function even when it is deformed into an arbitrary shape.

However, when producing a cellular phone having such flexibility and arbitrary shape property, there can be predicted the occurrence of a problem that the position of the antenna and circuit board relative to each other is varied to thereby shift an impedance matching with respect to the antenna. Such problem cannot be solved by the control technology disclosed in JP-A-2004-15307, because it is based on checking whether the body is folded or not.

### SUMMARY

According to an embodiment of the invention, there is provided a wireless communication terminal including; a deformable body made of a flexible material; an antenna; a radio frequency part of which a position relative to the antenna is valiable according to a deformation of the deformable body; a strain sensor detecting the deformation of the deformable body; a matching circuit acquiring an impedance matching with respect to the antenna; and a matching control unit configured to make matching control of the matching circuit according to a result of the detection of the strain sensor.

### BRIEF DESCRIPTION OF THE DRAWINGS

In the accompanying drawings:

FIG. 1 is an exemplary block diagram of a wireless communication terminal according to an embodiment of the invention;

FIG. 2 is an exemplary block diagram of main parts used in the wireless communication terminal;

FIGS. 3A, 3B are exemplary general views of an example of a strain sensor used in the wireless communication terminal;

FIG. 4 is an exemplary general view of an example of a strain sensor used in the wireless communication terminal;

FIG. 5A, 5B, 5C are exemplary block diagrams of main parts used in the wireless communication terminal;

FIG. 6 is an exemplary view of the contents of a table used in the wireless communication terminal; and

FIG. 7 is an exemplary flow chart to explain an operation to be executed according to a variation in the shape of a body used in the wireless communication terminal.

### DESCRIPTION OF THE EMBODIMENTS

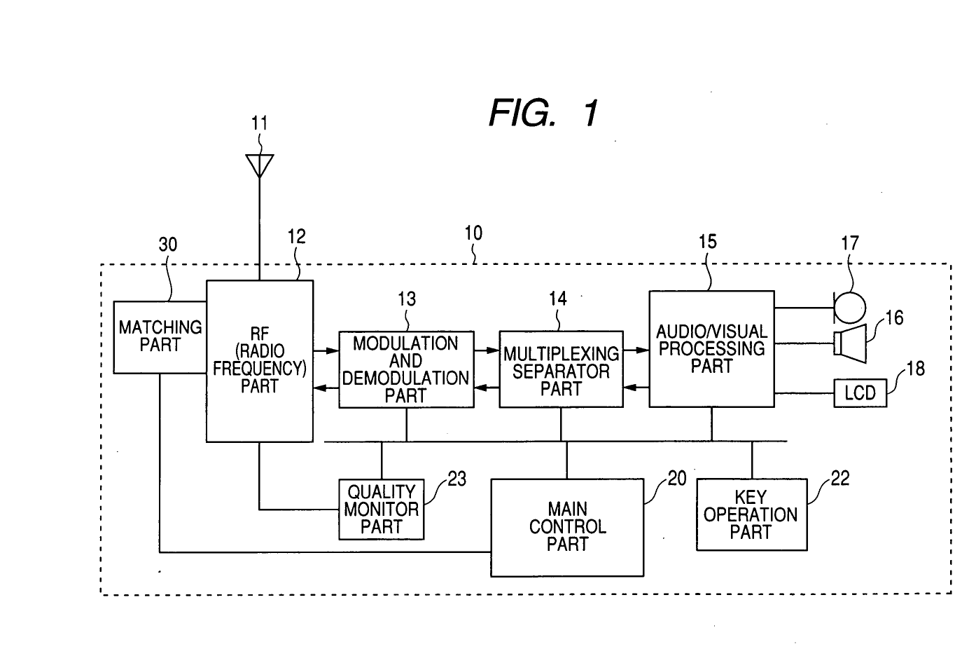

Now, description will be given below of a wireless communication terminal according to an embodiment of the invention with reference to the accompanying drawings. In the respective figures, the same composing elements are given the same designations and the duplicate description thereof is omitted. FIG. 1 shows a structure of a cellular phone serving as the wireless communication terminal according to an embodiment. An antenna 11 is connected to a RF(Radio Frequency) part (an RF circuit) 12. A modulator and demodulator part 13 is connected to the RF (Radio Frequency) part 12. A multiplexing separator part 14 is connected to the modulator and demodulator part 13. An audio/visual processing part 15 is connected to the multiplexing separator part 14. A speaker 16, a microphone 17 and an LCD (display device) 18 are connected to the audio/visual processing part 15.

The multiplexing separator part 14 and audio/visual processing part 15 are respectively connected to a main control part 20 which includes a CPU. To the main control part 20, there are connected a key operation part 22, a quality monitor part 23 and a matching part 30, respectively.

A signal coming from the antenna 11 is received and down-converted by the RF (Radio Frequency) part (RF circuit) 12, is then transmitted to and demodulated by the modulator and demodulator part 13, and is further transmitted to the multiplexing separator part 14. The multiplexing separator part 14 separates the multiplexed information into control information and audio/visual information. The control information is transmitted to the main control part 20, whereas the audio/visual information is transmitted to the audio/visual processing part 15. The audio/visual processing part 15 processes the audio/visual information into an audio signal and a visual signal. The audio signal is output from the speaker 16, whereas the visual signal is transmitted to the LCD (display device) 18, where an image is displayed. The antenna 11 includes a general monopole antenna (a whip antenna, an inverted F antenna, an inverted L antenna and the like), a loop antenna, a folded antenna, a dipole antenna, and the like; arid, the antenna 11 may be composed of a single antenna or two or more antennas.

The sound, which is input from the microphone 17, is processed by the audio/visual processing part 15 into data, and the data are transmitted to the multiplexing separator part 14. The multiplexing separator part 14 multiplexes the data transmitted from the audio/visual processing part 15 as well as the control information and character information transmitted from the main control part 20 into a signal; and then, the signal is transmitted to the modulator and demodulator part 13, where the signal is modulated. The modulated signal is received by the RF (Radio Frequency) part (RF circuit) 12, where the signal is up-converted and is then transmitted from the antenna 11.

The quality monitor part 23 acquires an electric field strength signal RSSI from the RF (Radio Frequency) part (RF circuit) 12 to monitor the receiving state of the RF(Radio Frequency) part 12, thereby helping the main control part 20 to select radio channels. By the way, in a cellular phone which is provided with a built-in camera, a video signal obtained by the camera is processed through the same route as the audio signal.

The matching part 30 controls an impedance matching according to a variation in the shape of the body 10. The body 10 maybe a part of resin, clothes or jewelry which a user wears. The body 10 may be made of a flexible material. The body 10 can be deformed in arbitrary shape due to its own flexibility. The relationship of the position and distance of the antenna 11 and RF (Radio Frequency) part 12 relative to each other are caused to vary according to a variation in the shape of the body 10.

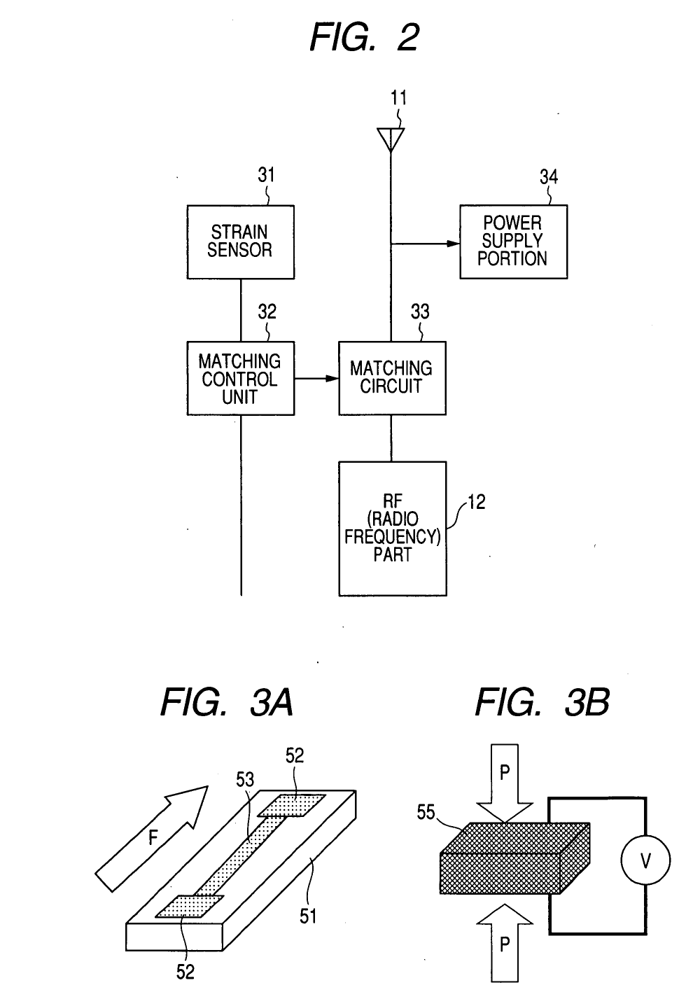

The matching part 30 is configured in such a manner as shown in FIG. 2. A strain sensor 31 is disposed at a position where the variation in the shape of the body 10 can be detected (for example, a position adjacent to the antenna 11 in the circuit board of the RF (Radio Frequency) part 12). The number of the strain sensor 31 may be one or more.

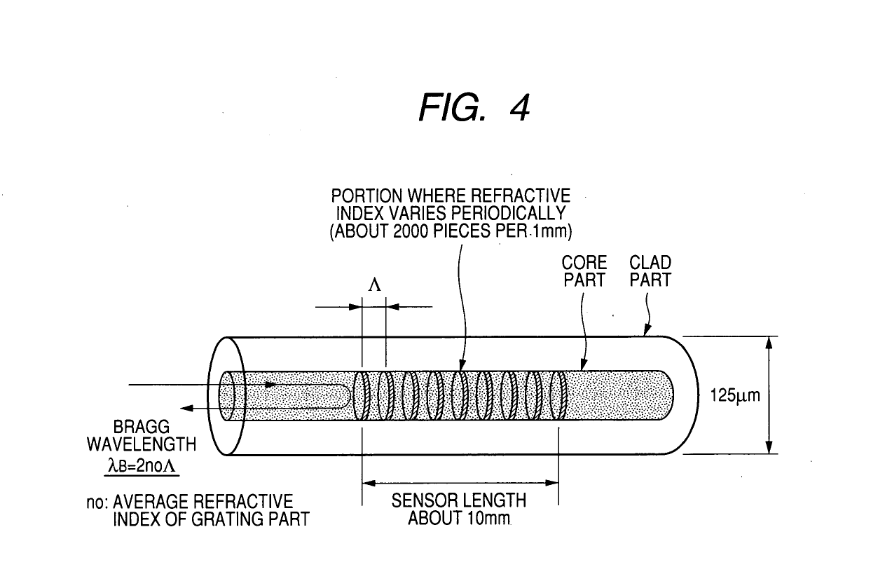

As the strain sensor 31, there can be used a strain gauge shown in FIG. 3A, or a piezoelectric element shown in FIG. 3B, or an optical fiber sensor shown in FIG. 4, or a combination thereof. The strain gauge is structured such that, in response to a strain caused by a force F which is applied to a circuit board 51 in such a manner as shown in FIG. 3A, a thin film resistor 53 interposed between a pair of electrodes 52, 52 varies its electric resistance. The piezoelectric element is structured such that it can generate a voltage V in response to a pressure P for deforming a circuit board 55. The optical fiber sensor is a device which generates reflection in its sensor length portion (in the example shown in FIG. 4, a portion having a length of about 10 mm) called a grating portion the refractive index of which varies periodically. In the optical fiber sensor, when a strain is applied thereto, the reflection wavelength is varied, so that the wavelength is measured to thereby acquire the amount of strain. Since the optical fiber sensor varies its output with respect to temperatures and loads applied thereto as well, use of the optical fiber sensor is ideal when external elements are collected widely to carry out an impedance matching operation. From the strain sensor 31, there is output, for example, a voltage which corresponds to the shape variation amount of the body 10; and, a matching control unit 32 converts the voltage into a digital signal and then transmits the digital signal to the main control part 20.

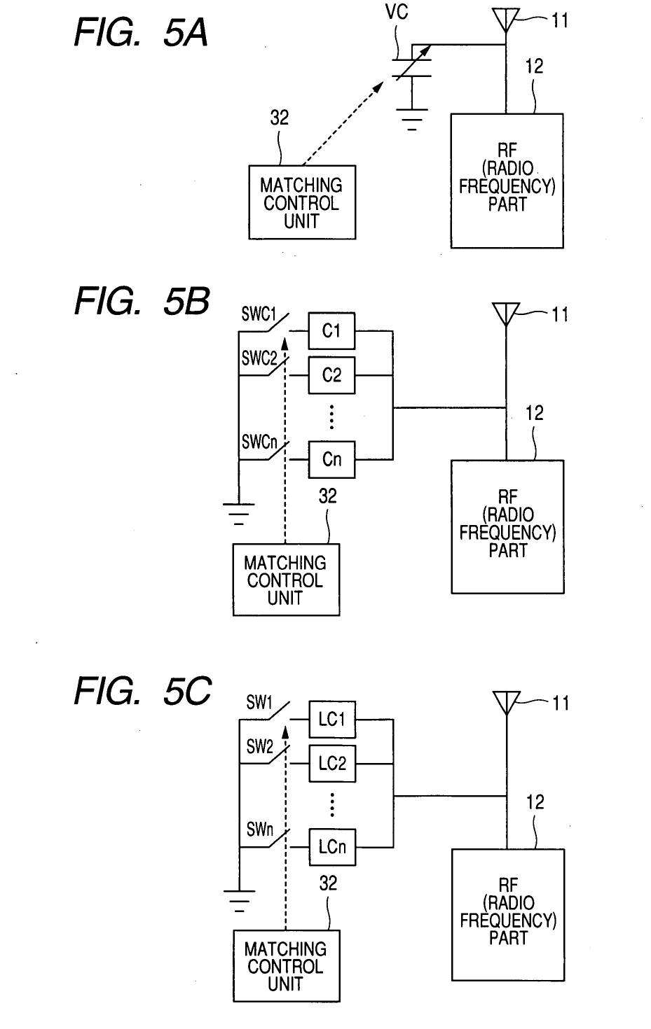

The matching part 30 includes a matching circuit 33 which acquires an impedance matching with respect to the antenna 11. For example, as shown in FIG. 5A, the matching circuit 33 can be configured by a variable capacitor Vc which is interposed between the antenna 11 and the ground. As exemplary shown in FIG. 5B, the matching circuit 33 may be configured by a plurality of capacitors C1˜Cn respectively interposed between the antenna 11 and the ground, and switches SWC1˜SWCn for selecting one or more of the capacitors. As exemplary shown in FIG. 5C, the matching circuit 33 may be configured by a plurality of LC circuits (such as series circuits each composed of a capacitor and a coil, or parallel circuits each composed of a capacitor and a coil) LC1˜LCn respectively interposed between the antenna 11 and the ground, and switches SW1˜SWn for selecting one or more of the LC circuits LC1˜LCn.

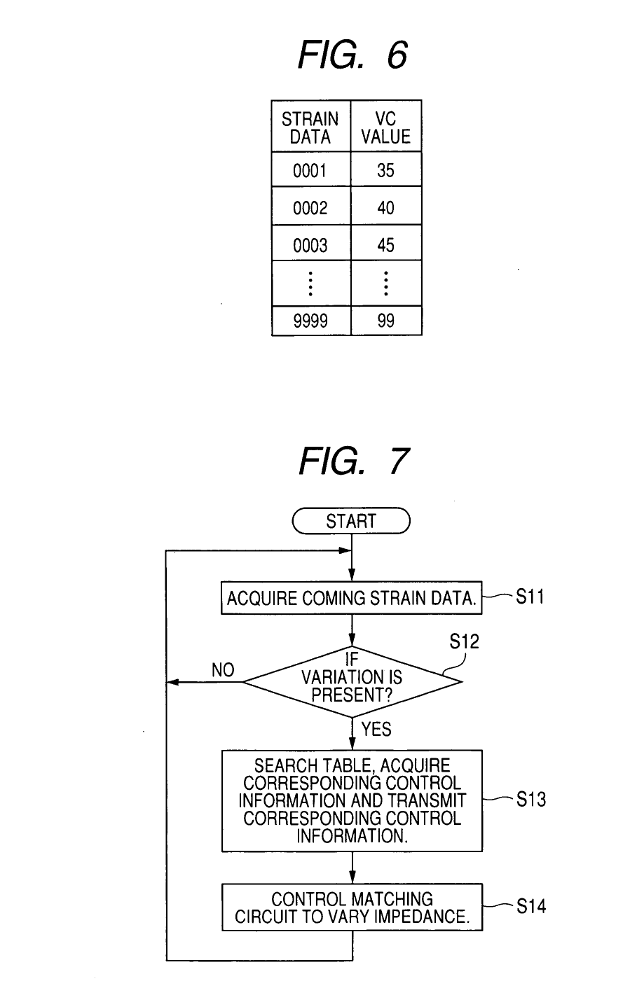

Power is supplied from a power supply portion 34 to the antenna 11. The main control part 20 includes such a control table as shown in FIG. 6 in which control information about the capacity of the variable capacitor value Vc is stored in correspondence to the output (strain data) from the matching control unit 32 acquired from a previously conducted experiment. In the control table shown in FIG. 6, the capacity of the variable capacitor value Vc shown in the left column thereof is regarded as the control information and is stored in correspondence to the strain data shown in the right column thereof. On the other hand, when there is used such switches as shown in FIG. 5B or 5C, control information expressing which switch is to be turned on (or off) is stored in correspondence to the strain data. The main control part 20 retrieves the control table to acquire the corresponding control information, and transmits the acquired control information to the matching control unit 32. The matching control unit 32 controls the matching circuit 33 according to the control information.

In connection with the above-structured cellular phone, description will be given below of the operation thereof to be carried out according to the variation in the shape of the body 10 with reference to a flow chart shown in FIG. 7. The main control part 20 takes in the strain data transmitted from the matching control unit 32 (S11), and checks the current strain data as to whether it has any variation relative to the previous strain data or not (S12). When it is detected that a variation is present, the main control part 20 searches the table to find out control information corresponding to such variation, and then transmits the thus-found corresponding control information to the matching control unit 32 (S13). The matching control unit 32 controls the matching circuit 33 according to the control information (S14). This can attain the necessary impedance matching.

In the above description, the control processing is carried out using the table. Alternatively, however, while varying the capacity of the variable capacitor VC in a given number of steps, information about the electric field strength signal RSSI may be acquired by the quality monitor part 23 to thereby find out the optimum capacity of the variable capacitor VC. Also, when there are used such switches as shown in FIG. 5B or 5C, while realizing all patterns for the switch on/off, in the respective switch states, a necessary number of pieces of information about the electric field strength signal RSSI may be acquired by the quality monitor part 23 and may be stored and finally, the stored electric field strength signals RSSI may be compared with each other to thereby find out the optimum switch state. Further, there may also be employed a technique in which, after execution of the control processing in the above-mentioned embodiment using the table, while realizing some of values near to the capacity value and LC value obtained by the control processing under the control of the main control part 20, a necessary number of pieces of information about the electric field strength signal RSSI are acquired by the quality monitor part 23 and are compared with each other to thereby realize the better capacity and LC value of the variable capacitor VC.

In a wireless communication terminal according to the above-described embodiments, a matching circuit for acquiring an impedance matching with respect to an antenna is matching controlled according to the detect output of a strain sensor which is used to detect a variation in the shape of a body.

What is claimed is:

1. A wireless communication terminal, comprising:
a deformable body made of a flexible material;
an antenna;
a radio frequency part of which a position relative to the antenna is valiable according to a deformation of the deformable body;
a strain sensor detecting the deformation of the deformable body;
a matching circuit acquiring an impedance matching with respect to the antenna; and
a matching control unit configured to make matching control of the matching circuit according to a result of the detection of the strain sensor.

2. A wireless communication terminal according to claim 1, wherein the strain sensor comprises at least one of a strain gauge, a piezoelectric element, and an optical fiber sensor.

3. A wireless communication terminal according to claim 1, wherein the matching circuit is configured by at least one of variable capacitor interposed between the antenna and a ground.

4. A wireless communication terminal according to claim 1, wherein the matching circuit is configured by a plurality of capacitors respectively interposed between the antenna and a ground, and a plurality of switches selecting at least one of the plurality of capacitors.

5. A wireless communication terminal according to claim 1, wherein the matching circuit is configured by a plurality of LC circuits respectively interposed between the antenna and a ground, and a plurality of switches selecting at least one of the plurality of LC circuits.

6. A wireless communication terminal, comprising:
a deformable body made of a flexible material;
an antenna;
a radio frequency part of which a distance relative to the antenna is valiable according to a deformation of the deformable body;
a strain sensor detecting the deformation of the deformable body;
a matching circuit acquiring an impedance matching with respect to the antenna; and
a matching control unit configured to make matching control of the matching circuit according to a result of the detection of the strain sensor.

7. A wireless communication terminal according to claim 6, wherein the strain sensor comprises at least one of a strain gauge, a piezoelectric element, and an optical fiber sensor.

8. A wireless communication terminal according to claim 6, wherein the matching circuit is configured by at least one of variable capacitor interposed between the antenna and a ground.

9. A wireless communication terminal according to claim 6, wherein the matching circuit is configured by a plurality of capacitors respectively interposed between the antenna and a ground, and a plurality of switches selecting at least one of the plurality of capacitors.

10. A wireless communication terminal according to claim 6, wherein the matching circuit is configured by a plurality of LC circuits respectively interposed between the antenna and a ground, and a plurality of switches selecting at least one of the plurality of LC circuits.
